(19) United States
(12) Patent Application Publication
(10) Pub. No.: US 2025/0234341 A1
(43) Pub. Date: Jul. 17, 2025

(54) METHOD OF TRANSMITTING DATA AND ELECTRONIC DEVICE FOR PERFORMING THE SAME

(71) Applicant: SAMSUNG ELECTRONICS CO., LTD., Suwon-si (KR)

(72) Inventors: Sumaiya SULTANA, Dhaka (BD); Mahmud Muntakim KHAN, Dhaka (BD); Eftikhar Azim, Dhaka (BD); Mahbubul HAQUE, Dhaka (BD); Yeasir ARAFAT, Dhaka (BD); Muhammad Mushfiqul ISLAM, Dhaka (BD); Muhammed Zeeshan CHOUDHURY, Dhaka (BD); Nafisa NAZNIN, Dhaka (BD); Sukanta SUTRADHAR, Dhaka (BD)

(73) Assignee: SAMSUNG ELECTRONICS CO., LTD., Suwon-si (KR)

(21) Appl. No.: 19/016,564

(22) Filed: Jan. 10, 2025

Related U.S. Application Data
(63) Continuation of application No. PCT/KR2024/020366, filed on Dec. 16, 2024.

(30) Foreign Application Priority Data
Jan. 15, 2024 (KR) 10-2024-0006307
Apr. 8, 2024 (KR) 10-2024-0047464

(51) Int. Cl. H04W 72/0453; H04W 72/542; H04W 76/15

(52) U.S. Cl. CPC H04W 72/0453; H04W 72/542; H04W 76/15

(57) ABSTRACT

An electronic device includes: memory storing one or more instructions; and at least one processor configured to execute the one or more instructions stored in the memory to: obtain first communication information on direct communication with an external device; obtain second communication information to indirect communication with the external device through an intermediate device; determine, based on the first communication information and the second communication information, a threshold value of a size of data for determining either the direct communication or the indirect communication; and determine, based on whether the size of the data exceeds the threshold value or not, a transmission method of transmitting the data to the external device.

### CROSS-REFERENCE TO RELATED APPLICATIONS

This application is a by-pass continuation application of International Application No. PCT/KR2024/020366, filed on Dec. 16, 2024, which is based on and claims priority to Korean Patent Application Nos. 10-2024-0006307, filed on Jan. 15, 2024, and 10-2024-0047464, filed on Apr. 8, 2024, in the Korean Intellectual Property Office, the disclosures of which are incorporated by reference herein their entireties.

### BACKGROUND

### 1. Field

The disclosure relates to a method of transmitting data and an electronic device for performing the method. The disclosure relates to a method of transmitting data through a data transmission technique selected based on collected information, and an electronic device for performing the method.

### 2. Description of Related Art

With developments in communication technologies, users may be provided with communication services by using Wi-Fi signals anywhere. The Wi-Fi signal may be transmitted and received between an access point (AP) device and a user terminal. A signal strength of the Wi-Fi signal may decrease as a distance between the user terminal and the AP device increases. The signal strength of the Wi-Fi signal an increased signal strength as the distance between the user terminal and the AP device decreases.

Also, in addition to the communication between the user terminal and the AP device, short-range wireless communication is possible between user terminals. For example, short-range wireless communication through a Bluetooth™ (in short, Bluetooth) signal is possible between the user terminals. When data is exchanged between the user terminals, the short-range wireless communication through the Bluetooth signal has a high data transmission rate, but additionally takes time to set a connection between the user terminals.

Thus, when data is transmitted between the user terminals, the short-range wireless communication through the Bluetooth signal and the communication through the Wi-Fi signal are complementarily used. When data having a large size is transmitted, the data may be transmitted relatively more quickly through the short-range wireless communication using the Bluetooth signal, and when data having a small size is transmitted, the data may be transmitted relatively more quickly through the communication using the Wi-Fi signal.

### SUMMARY

According to an aspect of the disclosure, a method, performed by a first device, includes: obtaining first communication information on direct communication between the first device and a second device; obtaining second communication information on indirect communication between the first device and the second device through an intermediate device; determining, based on the first communication information and the second communication information, a threshold value for determining either the direct communication or the indirect communication; and determining, based on a determination that a size of data exceeds the threshold value or not, either the direct communication or the indirect communication as a communication method of transmitting the data from the first device to the second device.

According to an aspect of the disclosure, an electronic device includes: memory storing one or more instructions; and at least one processor configured to execute the one or more instructions stored in the memory to: obtain first communication information on direct communication with an external device; obtain second communication information to indirect communication with the external device through an intermediate device; determine, based on the first communication information and the second communication information, a threshold value of a size of data for determining either the direct communication or the indirect communication; and determine, based on whether the size of the data exceeds the threshold value or not, a transmission method of transmitting the data to the external device.

According to an aspect of the disclosure, a computer-readable recording intermediate device having recorded thereon a program for executing: obtaining, by a first device, first communication information on direct communication between the first device and a second device; obtaining, by the first device, second communication information on indirect communication between the first device and the second device through an intermediate device; determining, by the first device, based on the first communication information and the second communication information, a threshold value for determining either the direct communication or the indirect communication; and determining, by the first device, based on a determination that a size of data exceeds the threshold value or not, either the direct communication or the indirect communication as a communication method of transmitting the data from the first device to the second device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a method, performed by an electronic device, of transmitting data, according to an embodiment of the disclosure.

FIG. 2 illustrates components of an electronic device according to an embodiment of the disclosure.

FIG. 3 illustrates a method of transmitting data according to an embodiment of the disclosure.

FIG. 4 illustrates a method, performed by an electronic device, of transmitting data to an external device, according to an embodiment of the disclosure.

FIG. 5 illustrates a method of obtaining communication information with respect to a Wi-Fi network, according to an embodiment of the disclosure.

FIG. 6 illustrates a method of transmitting data, the size of which exceeds a threshold value, according to an embodiment of the disclosure.

FIG. 7 illustrates a method of transmitting data, the size of which is less than a threshold value, according to an embodiment of the disclosure.

FIG. 8 illustrates a condition in which data, the size of which exceeds a threshold value, is transmitted, and a method of transmitting the data.

FIG. 9 illustrates a method of transmitting data to an external device, for which a communication connection is not set with the same intermediate device, according to an embodiment of the disclosure.

### DETAILED DESCRIPTION

In describing the disclosure, technical aspects well known in the art of the disclosure and not directly relevant to the disclosure will not be described. This is not to blur and to more clearly deliver the gist of the disclosure by omitting unnecessary descriptions. Also, the terms described below are defined by considering the functions in the disclosure and may be changed according to an intention of a user or operator, a precedent, etc. Thus, the terms shall be defined based on the content throughout the specification.

Likewise, some of components in the accompanying drawings are exaggerated, omitted, or schematically illustrated. Also, the size of each component does not completely reflect the actual size. In each drawing, the same reference numeral is assigned to the same or corresponding component.

The advantage or characteristics of the disclosure and the method of achieving the same will be apparent with reference to embodiments described below together with the accompanying drawings. However, the disclosure is not limited to the embodiments disclosed hereinafter and may be realized in various different forms. The disclosed embodiments are provided to fully disclose the disclosure and completely convey the scope of the disclosure to one of ordinary skill in the art. An embodiment of the disclosure may be defined according to the claims. The same reference numerals indicate the same components throughout the specification. Also, in describing an embodiment of the disclosure, when it is determined that a detailed description of a relevant function or component may unnecessarily blur the gist of the disclosure, the detailed description is omitted. Also, the terms described below are defined by considering the functions in the disclosure and may be changed according to an intention of a user or operator, a precedent, etc. Thus, the terms shall be defined based on the content throughout the specification.

The terms as used in the disclosure are provided to merely describe specific embodiments, not intended to limit the scope of other embodiments. Singular forms include plural referents unless the context clearly dictates otherwise. The terms and words as used herein, including technical or scientific terms, may have the same meanings as generally understood by those skilled in the art. The terms as generally defined in dictionaries may be interpreted as having the same or similar meanings as or to contextual meanings of the relevant art. Unless otherwise defined, the terms should not be interpreted as ideally or excessively formal meanings. Even though a term is defined in the disclosure, the term should not be interpreted as excluding embodiments of the disclosure under circumstances.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. As an additional example, the expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items. Moreover, multiple functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as Read Only Memory (ROM), Random Access Memory (RAM), a hard disk drive, a Compact Disc (CD), a Digital Video Disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

According to an embodiment of the disclosure, each of blocks of flowcharts and combinations of the flowcharts may be performed by computer program instructions. The computer program instructions may be loaded on a processor of a general-purpose computer, a special-use computer, or other programmable data processing device, and the instructions performed by the processor of the computer or the other programmable data processing device may generate a means for performing the functions described in the flowchart block(s). The computer program instructions may be stored in a computer-usable or computer-readable memory, which may be oriented for a computer or other programmable data processing device, in order to realize a function in a specific method, and the instructions stored in the computer-usable or computer-readable memory may also generate a manufacturing item including an instruction means for performing the functions described in the flowchart block(s). The computer program instructions may also be loaded on a computer or other programmable data processing device.

Furthermore, each block in the flowchart may represent a part of a module, segment, or a code including one or more executable instructions for performing (a) specific logic function(s). According to an embodiment of the disclosure, the functions described with respect to the blocks may also be performed without following the order. For example, two blocks illustrated in succession may be executed substantially concurrently or may sometimes be executed in a reverse order, depending on the functions involved therein.

The terms “unit” and “module” used in an embodiment of the disclosure may indicate a software component and/or a hardware component such as a field programmable gate array (FPGA) or an application specific integrated circuit (ASIC), and the unit or the module may perform a certain role. However, the “unit” and the “module” are not limited to indicate software or hardware. The “unit” and the “module” may be configured to be located in a storage medium which may be addressed or may be configured to play one or more processors. According to an embodiment of the disclosure, the “unit” or the “module” may include components, such as software components, object-oriented software components, class components, and task components, processes, functions, attributes, procedures, sub-routines, segments of a program code, drivers, firmware, a microcode, a circuit, data, a database, data structures, tables, arrays, and variables. Functions provided through the “unit” or the “module” may be combined to reduce the number of functions or may be divided into additional components. Also, according to an embodiment of the disclosure, the “unit” or the “module” may include one or more processors.

In the disclosure, direct communication may indicate a communication method in which devices are directly connected to each other. An electronic device may directly receive or transmit data from or to an external device through the direct communication. For example, the direct communication may be realized through Wi-Fi direct (Wi-Fi P2P), Bluetooth™ (in short, Bluetooth), Bluetooth low energy (BLE), near-field communication (NFC), a universal serial bus (USB) connection, etc.

In the disclosure, indirect communication may indicate a communication method in which an intermediate device is required for communication between devices. The indirect communication may indicate a communication method in which a connection is set between devices through the intermediate device. An electronic device may set a network connection with an external device through a router or an access point. For example, the indirect communication may be realized through a Wi-Fi local area network (LAN). In some embodiments, the intermediate device is called as a medium.

The direct communication may take time for setting a direct connection between devices. However, a data transmission method using the direct communication may generally have a higher transmission rate than a data transmission method using the indirect communication. Thus, when data of a large size is transmitted, it may be preferable to transmit the data using the direct communication. When data of a small size is transmitted, it may be preferable to transmit the data using the indirect communication.

Hereinafter, embodiments of the disclosure will be described by referring to the accompanying drawings.

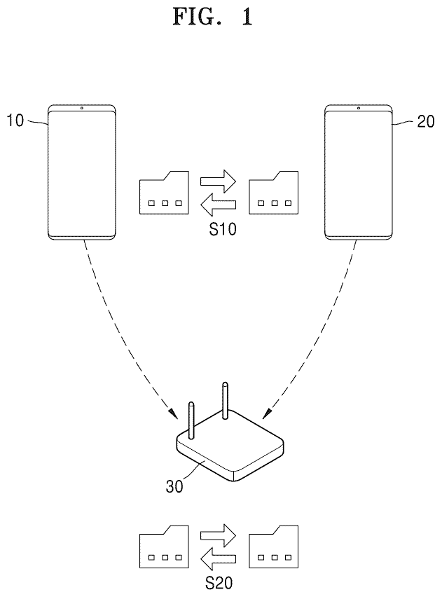

FIG. 1 illustrates a method, performed by an electronic device, of transmitting data, according to an embodiment of the disclosure. Referring to FIG. 1, a first device 10, a second device 20, and an intermediate device 30 (such as an access point (AP) device) are illustrated.

An electronic device according to an embodiment of the disclosure may transmit data to an external device. The electronic device may determine a communication method based on the size of data and communication information according to a communication method. The electronic device may transmit the data to the external device based on the determined communication method. The electronic device may determine an efficient communication method according to a condition, and thus, may improve the data transmission rate.

For example, the electronic device may correspond to the first device 10 and the external device may correspond to the second device 20 in FIG. 1. Hereinafter, a method of transmitting data will be described, based on the first device 10 and the second device 20.

In operation S10, the first device 10 may perform direct, wireless communication with the second device 20 to transmit data to the second device 20. The first device 10 may directly transmit the data to the second device 20. The first device 10 may transmit the data through a direct communication method such as BLE, Wi-Fi direct, etc.

In operation S20, the first device 10 may be indirectly connected to the second device 20 through the intermediate device 30 and may transmit data to the second device 20. The first device 10 may indirectly transmit the data to the second device 20 by using the intermediate device 30. The second device 20 may transmit data through an indirect communication method such as a Wi-Fi LAN.

For reference, as the size of data for transmission increases, it is preferable to transmit the data through a direct communication method, and as the size of data for transmission decreases, it is preferable to transmit the data through an indirect communication method. This is because while the direct communication method has a high data transmission rate, the direct communication method additionally takes time to set direct communication between the first device 10 and the second device 20.

According to an embodiment of the disclosure, the first device 10 may determine one from the communication method according to operation S10 and the communication method according to operation S20. The first device 10 may obtain first communication method with respect to the direct communication method between the first device 10 and the second device 20. The first device 10 may obtain second communication method with respect to the indirect communication method between the first device 10 and the second device 20 through the intermediate device 30. The first device 10 may determine one of the direct communication method and the indirect communication method, based on the first communication information and the second communication information.

According to an embodiment of the disclosure, the first device 10 may transmit data to the second device 20 based on the determined communication method. The communication method may be determined based on the size of data for transmission, a signal strength of the communication method, and a network frequency of the communication method.

For example, a data size threshold value at which the data transmission rate according to the indirect communication method or the direct communication method is reversed, may be determined, according to the signal strength of the communication method and the network frequency of the communication method. For example, the data size threshold value may be 50 MB. When the size of the data for transmission is less than 50 MB, it may be preferable for the first device 10 to transmit the data through the indirect communication method, and when the size of the data for transmission is greater than 50 MB, it may be preferable for the first device 10 to transmit the data through the direct communication method.

However, when the signal strength of the direct communication method decreases, the data size threshold value may increase. In this case, the data size threshold value may be determined to be 60 MB. When the size of the data for transmission is less than 60 MB, the first device 10 may transmit the data through the indirect communication method, and when the size of the data for transmission is greater than 60 MB, the first device 10 may transmit the data through the direct communication method.

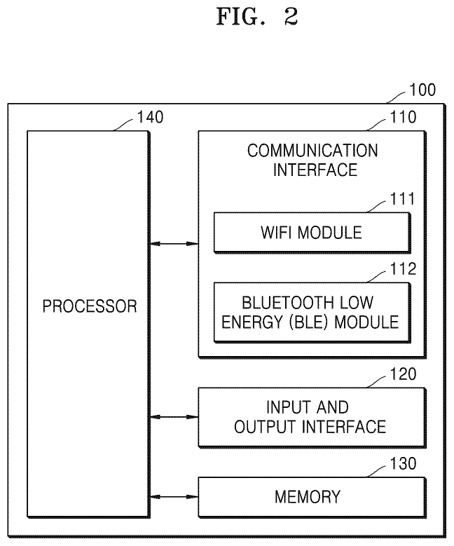

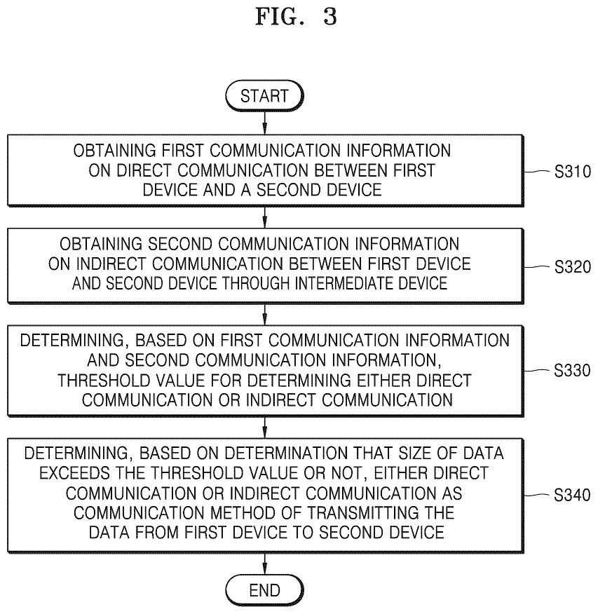

A method of determining the data size threshold value will be described in more detail with reference to FIGS. 3 to 9. FIG. 2 illustrates components of an electronic device 100 according to an embodiment of the disclosure.

Referring to FIG. 2, the electronic device 100 according to an embodiment of the disclosure may include a communication interface 110, an input and output interface 120, a memory 130, and a processor 140. However, components of the electronic device 100 are not limited to the example described above, and the electronic device 100 may include more or less components than the components described above. According to an embodiment of the disclosure, some or all of the communication interface 110, the input and output interface 120, the memory 130, and the processor 140 may be realized as one chip, and the processor 140 may include one or more processors. The one or more processors may include one or more of a central processing unit (CPU), a graphics processing unit (GPU), an accelerated processing unit (APU), a many integrated core (MIC), a field-programmable gate array (FPGA), a digital signal processor (DSP), a neural processing unit (NPU), a hardware accelerator, or a machine learning accelerator. The one or more processors are able to perform control of any one or any combination of the other components of the computing device, and/or perform an operation or data processing relating to communication. The one or more processors execute one or more programs stored in a memory.

The one or more processors may be implemented as one or more multi-core processors that include one or more cores (e.g., homogeneous multi-cores or heterogeneous multi-cores). When a plurality of cores are included in a processor, each of the cores includes a cache memory, and a common cache shared by the cores may be included in the processor. Each of the cores may independently read and execute program instructions or each of the cores may read and execute one or more portions of program instructions.

In embodiments of the disclosure, the processor may refer to a system-on-a-chip (SoC) in which one or more cores and other electronic components are integrated, a single core processor, a multicore processor, or a core included in the single core processor or the multicore processor, wherein the core may be implemented as a CPU, a GPU, an APU, an MIC, an FPGA, a DSP, an NPU, a hardware accelerator, or a machine learning accelerator, but the embodiments of the disclosure are not limited thereto.

The communication interface 110 may be configured to transmit and receive a signal (a control command, data, etc.) to and from an external device with wires or wirelessly and may be configured to include a communication chip set for supporting various communication protocols. According to an embodiment of the disclosure, the communication interface 110 may include a Wi-Fi module 111 and a BLE module 112 to support Wi-Fi communication and BLE communication.

The Wi-Fi module 111 may be implemented with at least one processor and peripheral components (such as memory, resistors, capacitors, or inductors). In an exemplary embodiment, the Wi-Fi module 111 may be implemented with software (computer codes). In another exemplary embodiment, the Wi-Fi module 111 may be implemented with combinations of the at least one processor, the peripheral components, and the software.

The BLE module 112 may be implemented with at least one processor and peripheral components (such as memory, resistors, capacitors, or inductors). In an exemplary embodiment, the BLE module 112 may be implemented with software (computer codes). In another exemplary embodiment, the BLE module 112 may be implemented with combinations of the at least one processor, the peripheral components, and the software.

Thus, the electronic device 100 may perform communication with an intermediate device (30 of FIG. 1) or an external device (20 of FIG. 1) through Wi-Fi and may perform communication with the external device through BLE.

For reference, the electronic device 100 may correspond to the first device 10 of FIG. 1, and the external device may correspond to the second device 20 of FIG. 1.

The communication interface 110 may receive a signal from the outside and output the signal to the processor 140 or may transmit a signal output from the processor 140 to the outside.

The input and output interface 120 may include an input interface (e.g., a power button, a touch screen, a function button, a microphone, etc.) for receiving a control command, information, or the like from a user and an output interface (e.g., a display panel, a speaker, etc.) for displaying an execution result of an operation according to control by a user or a state of the electronic device 100.

The memory 130 may store various programs or data and may include storage media, such as read-only memory (ROM), random-access memory (RAM), a hard disk, compact disc (CD)-ROM, and a digital versatile disc (DVD), or a combination of the storage media. The memory 130 may not be separately provided and may be included in the processor 140 to be described below. The memory 130 may include a volatile memory, a non-volatile memory, or a combination of the volatile memory and the non-volatile memory. The memory 130 may store a program for performing operations according to embodiments of the disclosure described below. The memory 130 may provide the stored data to the processor 140 in response to a request by the processor 140. According to an embodiment of the disclosure, the memory 130 may store not only the data to be transmitted to the external device, but also a program for determining a communication method for transmitting the data to the external device.

The processor 140 may write data in the memory 130 or read data stored in the memory 130, and particularly, may process data according to a pre-defined operation rule or AI model by executing a program stored in the memory 130. Thus, the processor 140 may perform the operations described below according to embodiments of the disclosure, and the operations described below as being performed by the electronic device 100, according to the embodiments of the disclosure, may be understood as being performed by the processor 140, unless there are particular explanations. According to an embodiment of the disclosure, the processor 140 may execute the program stored in the memory 130 to perform a process of determining a communication method for transmitting data to the external device.

FIG. 3 illustrates a method of transmitting data, according to an embodiment of the disclosure.

For reference, each of operations in FIG. 3 may indicate a general operation performed between a first device and a second device. However, according to an embodiment of the disclosure, the first device may perform the operation according to each operation. The first device may correspond to the electronic device 100 of FIG. 2.

Referring to FIG. 3, in operation S310, first communication information about direct communication between the first device and the second device may be obtained. The first device may obtain the first communication information.

According an embodiment of the disclosure, the first device may directly receive data from the second device through the direct communication. The first device may directly transmit data to the second device through the direct communication. The direct communication may be set, for example, through a Wi-Fi direct (Wi-Fi P2P) method.

According to an embodiment of the disclosure, the first communication information may be information about the direct communication set between the first device and the second device. The first communication information may include at least one of a network frequency of the direct communication or a signal strength of the direct communication. For example, the signal strength may be measured as a received signal strength indicator (RSSI) value. In some embodiments, the RSSI value is a relative determination of the signal strength and may be expressed in decibel-milliwatts (dBm).

The network frequency of the direct communication may include frequencies of a band in which direction communication between the first device and the second device is possible. The first device and the second device may be connected to each other based on the network frequency of the direct communication.

The signal strength of the direct communication may include a signal strength of the direct communication between the first device and the second device. For example, the signal strength of the direct communication may indicate the reception strength of a Wi-Fi direct signal received through a communication circuit (for example, a Wi-Fi card or the Wi-Fi module 111, etc.). The signal strength may be a value represented by a decibel-milliwatts (dBm) unit.

According to an embodiment of the disclosure, after the first device sets the direct communication with the second device, the first device may obtain the first communication information about the direct communication that is set. According to an embodiment of the disclosure, the first device may obtain the first communication information about the direct communication with the second device from a memory. However, the method of obtaining the first communication information is only an example and does not limit the technical aspect of the disclosure.

In operation S320, second communication information about indirect communication between the first device and the second device through the intermediate device may be obtained. The first device may obtain the second communication information.

According to an embodiment of the disclosure, the first device may receive data from the second device through the indirect communication. The first device may transmit data to the second device through the indirect communication. The first device may set the indirect communication with an external device through the intermediate device. For example, the first device may set a network connection with the external device through a router or an access point, which is a non-limiting example of the intermediate device. For example, the indirect communication may be set through a Wi-Fi LAN or Bluetooth.

According to an embodiment of the disclosure, the second communication information may be information about the indirect communication set between the first device and the second device. The second communication information may include at least one of a network frequency of the indirect communication or a signal strength of the indirect communication.

According to an embodiment of the disclosure, the indirect communication may include a first connection between the first device and the intermediate device and a second connection between the second device and the intermediate device. The second communication information may include at least one of a network frequency of the first connection, a signal strength of the first connection, a network frequency of the second connection, or a signal strength of the second connection.

The network frequency of the indirect communication may include frequencies of a band in which indirection communication between the first device and the second device is possible. The first device and the second device may be connected to each other based on the network frequency of the indirect communication.

According to an embodiment of the disclosure, the network frequency of the first connection and the network frequency of the second connection may be the same as each other. The first device may be connected to the second device based on the same network frequency.

According to an embodiment of the disclosure, the network frequency of the first connection and the network frequency of the second connection may be different from each other. In this case, the first device may determine a weaker network frequency of the network frequency of the first connection and the network frequency of the second connection as the network frequency of the indirect communication. The second communication information may include the weaker network frequency of the network frequency of the first connection and the network frequency of the second connection.

The signal strength of the indirect communication may include a signal strength of the indirect communication between the first device and the second device. For example, the signal strength of the indirect communication may indicate the reception strength of a Wi-Fi LAN signal or Bluetooth received through a communication circuit. The signal strength may be a value represented by a dBm unit.

According to an embodiment of the disclosure, the signal strength of the first connection and the signal strength of the second connection may be the same as each other. In this case, the first device may be indirectly connected to the second device through the intermediate device, and the signal strength of the indirect communication may be the same as the signal strength of the first connection or the signal strength of the second connection.

According to an embodiment of the disclosure, the signal strength of the first connection and the signal strength of the second connection may be different from each other. In this case, the first device may determine a weaker signal strength of the signal strength of the first connection and the signal strength of the second connection as the signal strength of the indirect communication. The second communication information may include the weaker signal strength of the signal strength of the first connection and the signal strength of the second connection.

In operation S330, a threshold value for determining one of the direct communication and the indirect communication may be determined based on the first communication information and the second communication information. The first device may determine the threshold value based on the first communication information and the second communication information.

According to an embodiment of the disclosure, the first device may determine the threshold value. The first device may determine the threshold value based on the first communication information and the second communication information. The threshold value may correspond to the size of data whereby the data transmission rate of the direct communication and the data transmission rate of the indirect communication are reversed. According to an embodiment of the disclosure, the threshold value may be related to the size of the data. For example, the threshold value may be related to the size of the data represented by a megabyte (MB) unit.

According to an embodiment of the disclosure, the threshold value for determining one of the direct communication and the indirect communication may be determined according to Equation 1. Equation 1 may be configured for determining the threshold value based on variables included in the first communication information and the second communication information, and Equation 1 is an example and does not limit the technical aspect of the disclosure.

$${x}^{′} = x * {R}_{ω} * {F}_{ω} / ( {R}_{d} * {F}_{d} ) \qquad [ Equation 1 ]$$

In Equation 1, x′ may indicate the threshold value. x′ may indicate the threshold value with respect to the size of data for transmission. In Equation 1, x may indicate an initial value. x may indicate the initial value with respect to the size of the data. x may be set as the initial value to calculate x′. For example, x may be arbitrarily set.

In Equation 1, R_{ω} may indicate a signal strength of the indirect communication. R_{ω} may be represented by a dBm unit. R_{ω} may indicate a signal strength selected from a signal strength between a first device and an intermediate device and a signal strength between a second device and the intermediate device.

According to an embodiment of the disclosure, the signal strength of the indirect communication may have a normalized value of between 0 and 100. R_{ω} may have one of normalized values of between 0 and 100.

According to an embodiment of the disclosure, the first device may select a weaker signal strength of the signal strength between the first device and the intermediate device and the signal strength between the second device and the intermediate device and may determine the selected weaker signal strength as the signal strength of the indirect communication. R_{ω} may indicate the selected weaker signal strength.

In Equation 1, F_{ω} may indicate a network frequency of the indirect communication. A multiplying factor corresponding to the network frequency of the indirect communication may substitute for F_{ω}. F_{ω} may indicate the multiplying factor corresponding to each frequency. For example, the multiplying factor of 1 may correspond to the frequency of 2.4 GHz and the multiplying factor of 5 may correspond to the frequency of 5 GHz. When the network frequency of the indirect communication is 2.4 GHz, F_{ω} may be 1, and when the network frequency of the indirect communication is 5 GHz, F_{ω} may be 5.

In Equation 1, R_{d} may indicate a signal strength of the direct communication. R_{d} may be represented by a dBm unit. R_{d} may indicate, for example, the signal strength between the first device and the second device.

According to an embodiment of the disclosure, the signal strength of the direct communication may have a normalized value of between 0 and 100. R_{d} may have one of normalized values of between 0 and 100.

In Equation 1, F_{d} may indicate a network frequency of the direct communication. A multiplying factor corresponding to the network frequency of the direct communication may substitute for F_{d}. F_{d} may indicate the multiplying factor corresponding to each frequency. For example, the multiplying factor of 1 may correspond to the frequency of 2.4 GHz and the multiplying factor of 5 may correspond to the frequency of 5 GHz. When the network frequency of the direct communication is 2.4 GHz, F_{d} may be 1, and when the network frequency of the direct communication is 5 GHz, F_{d} may be 5.

According to an embodiment of the disclosure, F_{d} may be a multiplying factor indirectly determined by R_{d} which is the signal strength of the direct communication. For example, when the normalized signal strength of the direct communication exceeds 90, it may be determined that the first device and the second device are connected to each other by the network frequency of 5 GHz, and the multiplying factor of 5 corresponding to 5 GHz may substitute for F_{d}. As another example, when the normalized signal strength of the direct communication does not exceed 90, it may be determined that the first device and the second device are connected to each other by the network frequency of 2.4 GHz, and the multiplying factor of 1 corresponding to 2.4 GHz may substitute for F_{d}.

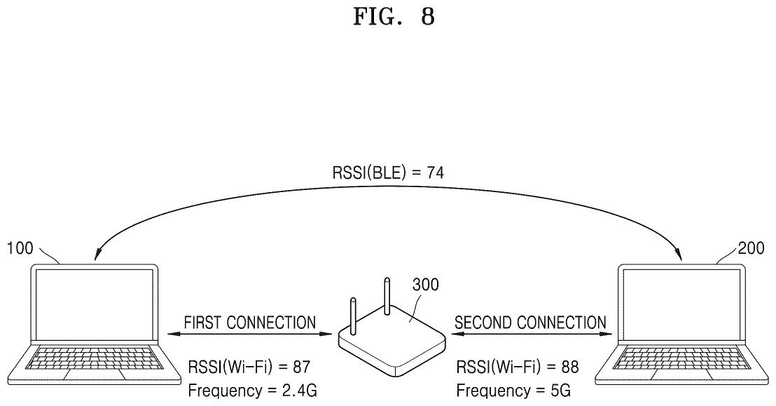

The threshold value may vary according to the signal strength of each communication method and the network frequency of each communication method. The threshold value may be inversely proportional to at least one of the network frequency of the direct communication or the signal strength of the direct communication. The threshold value may be proportional to at least one of the network frequency of the indirect communication or the signal strength of the indirect communication. The method of determining the threshold value by using Equation 1 will be described below by using FIG. 8 illustrating an example of a detailed condition and Equation 1.

In operation S340, based on a determination that the size of the data exceeds the threshold value or not, a communication method of transmitting the data from the first device to the second device may be determined. The first device may determine the communication method of transmitting data to the second device, based on whether or not the size of the data exceeds the threshold value.

According to an embodiment of the disclosure, when the size of the data increases, it may be preferable to transmit the data between the first device and the second device through direct communication. The first device may determine whether or not the size of the data to be transmitted exceeds the threshold value. When the size of the data to be transmitted exceeds the threshold value, the first device may determine to transmit the data through the direct communication. When the size of the data to be transmitted is less than the threshold value, the first device may determine to transmit the data through the indirect communication.

According to an embodiment of the disclosure, the data may be transmitted from the first device to the second device, based on the determined communication method. For example, data of the size exceeding the threshold value may be transmitted from the first device to the second device through the direct communication. As another example, data of the size less than the threshold value may be transmitted from the first device to the second device through the indirect communication.

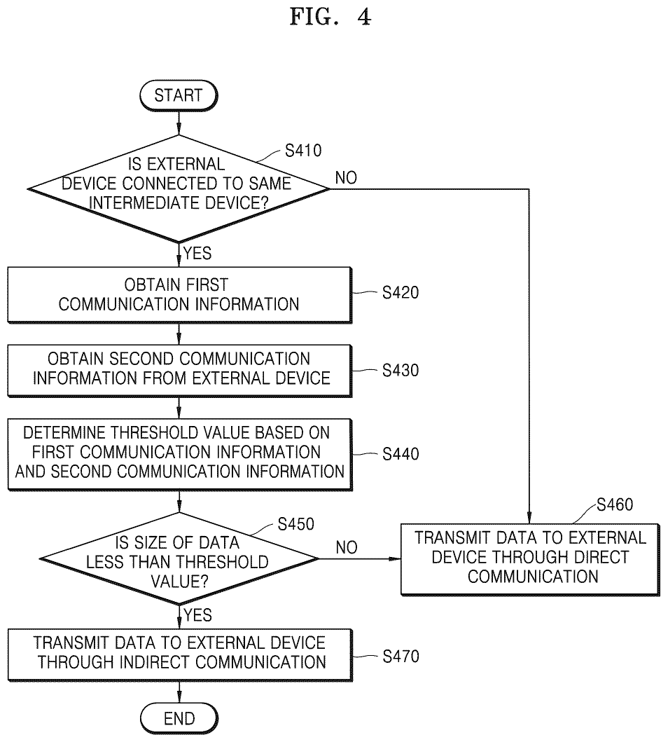

FIG. 4 illustrates a method, performed by an electronic device, of transmitting data to an external device, according to an embodiment of the disclosure. By referring to FIG. 4, a process in which the electronic device performs each of operations, is described.

Referring to FIG. 4, in operation S410, the electronic device may acquire whether or not the external device is connected to the same intermediate device.

According to an embodiment of the disclosure, the electronic device may search for the external device. The electronic device may be connected to an intermediate device for communication and may search for an external device connected to the same intermediate device. The electronic device may search for an external device in the vicinity thereof and may request the external device to identify whether or not the external device is connected to the same intermediate device. The electronic device may receive, from the external device, a response with respect to the identification of whether or not the external device is connected to the same intermediate device. For example, the intermediate device may include or correspond to a router or an access point.

When the external device is not connected to the same intermediate device, the electronic device may perform operation S460. In operation S460, the electronic device may transmit data to the external device through direct communication.

According to an embodiment of the disclosure, the case in which the external device is not connected to the same intermediate device may include a case in which while the electronic device is connected to an intermediate device, the external device is not connected to the intermediate device connected to the electronic device. According to an embodiment of the disclosure, the case in which the external device is not connected to the same intermediate device may include a case in which the electronic device and the external device are connected to different intermediate devices from each other.

According to an embodiment of the disclosure, the electronic device may search for the external device. The electronic device may set direct communication with the searched external device. The electronic device may exchange data with the external device through the direct communication. For example, the direct communication may include Wi-Fi direct (Wi-Fi P2P), Bluetooth, BLE, NFC, a USB

In operation S420, the electronic device may obtain first communication information. The description about operation S420 may be the same as described with reference to operation S310 of FIG. 3, and thus, is briefly given.

The first communication information may be information about the direct communication set between the electronic device and the external device. The first communication information may include at least one of a network frequency of the direct communication or a signal strength of the direct communication.

According to an embodiment of the disclosure, after the electronic device sets the direct communication with the external device, the electronic device may obtain the first communication information about the direct communication that is set. According to an embodiment of the disclosure, the electronic device may obtain, from a memory, the first communication information about the direct communication with the external device. However, the method of obtaining the first communication information is only an example and does not limit the technical scope of the disclosure.

In operation S430, the electronic device may obtain second communication information from the external device. The description about operation S430 may be the same as described with reference to operation S320 of FIG. 3, and thus, is briefly given.

According to an embodiment of the disclosure, the second communication information may be information about indirect communication set between the electronic device and the external device. The second communication information may include at least one of a network frequency of the indirect communication or a signal strength of the indirect communication.

According to an embodiment of the disclosure, the electronic device may receive data from the external device through the indirect communication. The electronic device may transmit data to the external device through the indirect communication. The electronic device may set the indirect communication with the external device through an intermediate device. For example, the electronic device may set a network connection with the external device through a router or an access point. For example, the indirect communication may be set through a Wi-Fi LAN or Bluetooth.

In operation S440, the electronic device may determine a threshold value based on the first communication information and the second communication information. The description about operation S440 may be the same as described with reference to operation S330 of FIG. 3, and thus, is briefly given.

According to an embodiment of the disclosure, the electronic device may determine the threshold value. The electronic device may determine the threshold value based on the first communication information and the second communication information. According to an embodiment of the disclosure, the threshold value may be related to the size of data.

According to an embodiment of the disclosure, the threshold value for determining one of the direct communication and the indirect communication may be determined according to Equation 1. The threshold value may vary according to the signal strength of each communication method and the network frequency of each communication method, and the method of determining the threshold value by using Equation 1 will be described below by using FIG. 8 illustrating an example of a detailed condition and Equation 1.

In operation S450, the electronic device may determine whether the size of data to be transmitted is less than the threshold value.

When the size of the data to be transmitted exceeds the threshold value, operation S460 may be performed. In operation S460, the electronic device may transmit the data to the external device through the direct communication.

According to an embodiment of the disclosure, the electronic device may search for the external device. The electronic device may set the direct communication with the searched external device. The electronic device may exchange the data with the external device through the direct communication. For example, the direct communication may include Wi-Fi direct (Wi-Fi P2P), Bluetooth, BLE, NFC, a USB connection, etc.

When the size of the data to be transmitted is less than the threshold value, operation S470 may be performed. In operation S470, the electronic device may transmit the data to the external device through the indirect communication.

According to an embodiment of the disclosure, the electronic device may transmit the data to the external device through the indirect communication. The electronic device may set the indirect communication with the external device through an intermediate device and may transmit the data to the external device. For example, the electronic device may set a network connection with the external device through a router or an access point. For example, the indirect communication may be set through a Wi-Fi LAN or Bluetooth.

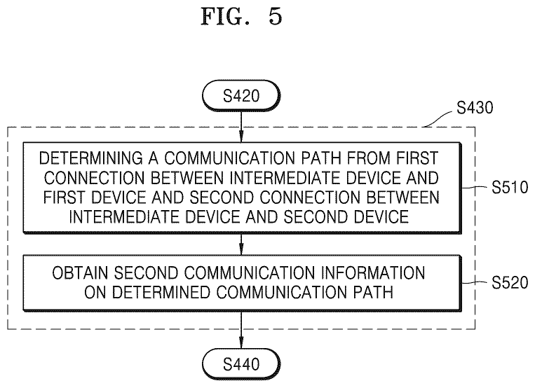

FIG. 5 illustrates a method of obtaining communication information with respect to a Wi-Fi network, according to an embodiment of the disclosure. Referring to FIG. 5, operation S430 of FIG. 4 may include operations S510 and S520.

In operation S510, the electronic device may determine a communication path from communication between the electronic device and the intermediate device and communication between the intermediate device and the external device. In operation S520, the electronic device may obtain the second communication information about the determined communication path.

According to an embodiment of the disclosure, the electronic device may obtain information about the signal strength with respect to the communication between the electronic device and the intermediate device and information about the signal strength with respect to the communication between the external device and the intermediate device. The electronic device may determine a communication path having a weak signal strength, based on the obtained information. The electronic device may obtain the second communication information with respect to the determined communication path.

For example, the signal strength with respect to the communication between the electronic device and the intermediate device may be weaker than the signal strength with respect to the communication between the external device and the intermediate device. The electronic device may obtain the information about the signal strength with respect to the communication between the electronic device and the intermediate device as the second communication information.

As another example, the signal strength with respect to the communication between the external device and the intermediate device may be weaker than the signal strength with respect to the communication between the electronic device and the intermediate device. The electronic device may obtain the information about the signal strength with respect to the communication between the external device and the intermediate device as the second communication information.

According to an embodiment of the disclosure, the electronic device may obtain information about a network frequency with respect to the communication between the electronic device and the intermediate device and information about a network frequency with respect to the communication between the external device and the intermediate device. The electronic device may determine a communication path having a weak network frequency, based on the obtained information. The weak network frequency may include frequencies in low bands.

For example, the network frequency with respect to the communication between the electronic device and the intermediate device may be lower than the network frequency with respect to the communication between the external device and the intermediate device. The electronic device may obtain the information about the network frequency with respect to the communication between the electronic device and the intermediate device as the second communication information.

As another example, the network frequency with respect to the communication between the external device and the intermediate device may be weaker than the network frequency with respect to the communication between the electronic device and the intermediate device. The electronic device may obtain the information about the network frequency with respect to the communication between the external device and the intermediate device as the second communication information.

According to an embodiment of the disclosure, the electronic device may obtain the information about the network frequency of the determined communication path as the second communication information, wherein the information about the network frequency may be provided in the form of a multiplying factor. For example, the multiplying factor of 1 may correspond to the frequency of 2.4 GHz and the multiplying factor of 5 may correspond to the frequency of 5 GHz. The information about the network frequency may be represented by 1 or 5.

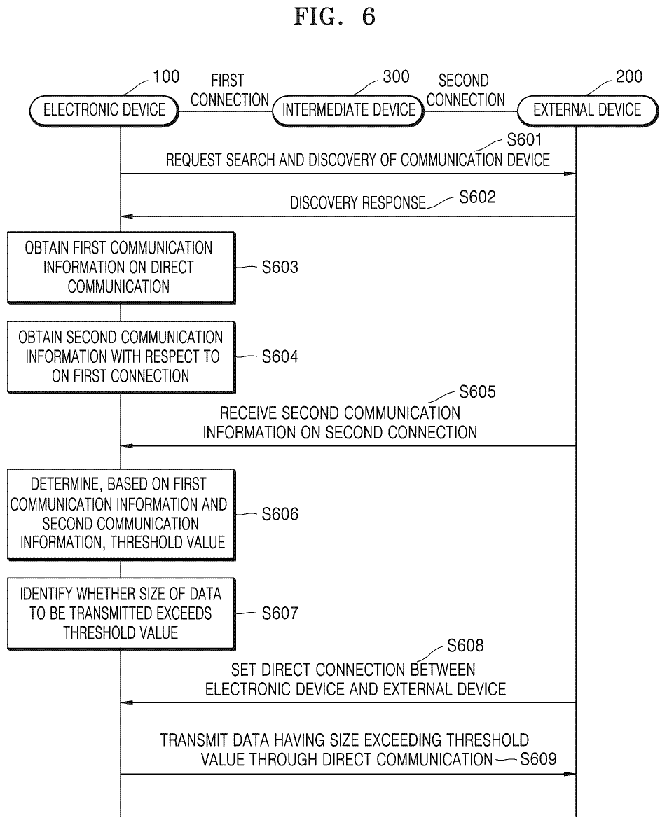

FIG. 6 illustrates a method of transmitting data, the size of which exceeds a threshold value, according to an embodiment of the disclosure.

Referring to FIG. 6, in operation S601, the electronic device 100 may search for a communication device in the vicinity thereof. The electronic device 100 may transmit a discovery request with respect to the communication device in the vicinity thereof. For example, the electronic device 100 may search for the communication device in the vicinity thereof to discover an external device 200. The electronic device 100 may transmit a discovery request with respect to the external device 200.

In operation S602, the electronic device 100 may receive a discovery response from the searched communication device. For example, the electronic device 100 may receive a discovery response from the external device 200.

According to an embodiment of the disclosure, the discovery request and the discovery response may be the data delivered for searching and detection between the devices.

In operation S603, the electronic device 100 may obtain first communication information with respect to direct communication. The description about operation S603 may be the same as described with reference to operation S310 of FIG. 3, and thus, is omitted.

According to an embodiment of the disclosure, the electronic device 100 may communicate with the external device 200 through an intermediate device 300 (e.g., an access point (AP) device, a router). The electronic device 100 may be connected to the external device 200 through the intermediate device 300. That is, the electronic device 100 may exchange data with the external device 200 through indirect communication.

According to an embodiment of the disclosure, the indirect communication may include a first connection between the electronic device 100 and the intermediate device 300 and a second connection between the external device 200 and the intermediate device 300.

According to an embodiment of the disclosure, the electronic device 100 may obtain second communication information with respect to the indirect communication. In operation S604, the electronic device 100 may obtain the second communication information with respect to the first connection. In operation S605, the electronic device 100 may receive the second communication information with respect to the second connection from the external device 200.

For example, the second communication information with respect to the first connection may include at least one of a network frequency of the first connection or a signal strength of the first connection. The second communication information with respect to the second connection may include at least one of a network frequency of the second connection or a signal strength of the second connection. Descriptions about operation S604 and operation S605 are the same as described with reference to operation S320 of FIG. 3, operation S430 of FIG. 4, and operation S520 of FIG. 5, and thus, are briefly given.

According to an embodiment of the disclosure, the electronic device 100 may receive the second communication information through the intermediate device 300, and the method of obtaining the second communication information does not limit the technical aspect of the disclosure.

In operation S606, the electronic device 100 may determine the threshold value based on the first communication information and the second communication information. The threshold value may be a threshold numerical value of the size of data for determining one of the direct communication and the indirect communication. The threshold value may be determined based on the first communication information and the second communication information, and may be determined based on the signal strength and the network frequency of the direct communication and the signal strength and the network frequency of the indirect communication. For example, the electronic device 100 may determine the threshold value based on Equation 1.

The description about operation S606 may be the same as described with reference to operation S303 of FIG. 3, and thus, is briefly given.

In operation S607, the electronic device 100 may identify whether the size of data to be transmitted exceeds the threshold value.

According to an embodiment of the disclosure, the electronic device 100 may determine the data to be transmitted according to an user input. The electronic device 100 may obtain the size of the data to be transmitted. The electronic device 100 may compare the size of the data to be transmitted with the threshold value determined in operation S606.

For reference, FIG. 6 illustrates the case in which the size of the data to be transmitted exceeds the threshold value. Thus, when it is determined that the size of the data to be transmitted exceeds the threshold value, operation S608 may be performed after operation S607.

In operation S608, the electronic device 100 may set a direct connection between the electronic device 100 and the external device 200. The direct connection may be realized through Wi-Fi direct (Wi-Fi P2P), Bluetooth, BLE, NFC, a USB connection, etc.

In operation S609, the electronic device 100 may transmit the data having the size exceeding the threshold value through the direct communication. The electronic device 100 may transmit the data to be transmitted to the external device 200 through the direct communication. The electronic device 100 may directly transmit data to the external device 200 without the help of the intermediate device 300.

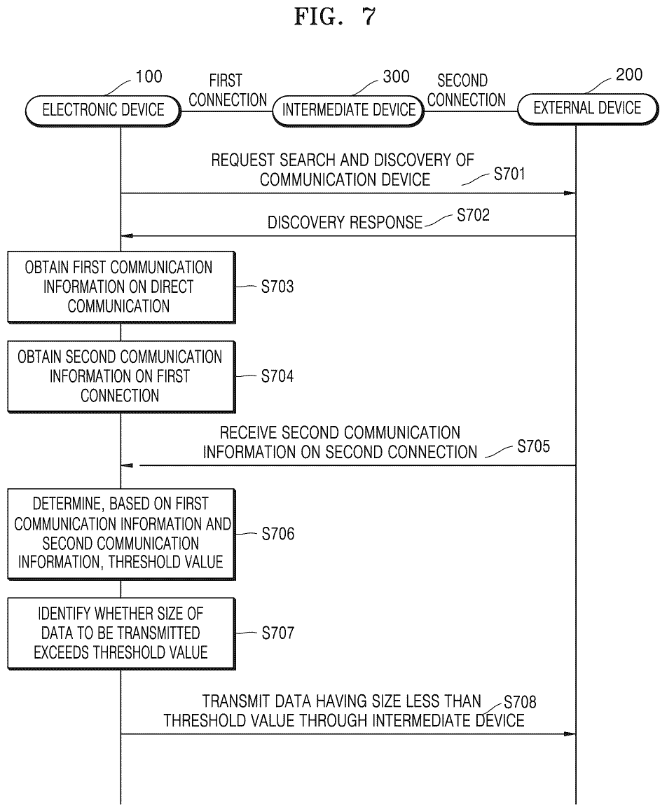

FIG. 7 illustrates a method of transmitting data, the size of which is less than a threshold value, according to an embodiment of the disclosure.

The descriptions about operations S701 to S707 are the same as described with reference to operations S601 to S607 of FIG. 6, and thus, are briefly given.

Referring to FIG. 7, in operation S701, the electronic device 100 may search for a communication device in the vicinity thereof. The electronic device 100 may transmit a discovery request with respect to the communication device in the vicinity thereof. In operation S702, the electronic device 100 may receive a discovery response from the searched communication device.

In operation S703, the electronic device 100 may obtain first communication information with respect to direct communication.

According to an embodiment of the disclosure, the electronic device 100 may exchange data with the external device 200 through indirect communication. According to an embodiment of the disclosure, the indirect communication may include or correspond to a first connection between the electronic device 100 and the intermediate device 300 and a second connection between the external device 200 and the intermediate device 300.

According to an embodiment of the disclosure, the electronic device 100 may obtain second communication information with respect to the indirect communication. In operation S704, the electronic device 100 may obtain the second communication information with respect to the first connection. In operation S705, the electronic device 100 may receive the second communication information with respect to the second connection from the external device 200.

In operation S706, the electronic device 100 may determine the threshold value based on the first communication information and the second communication information. In operation S707, the electronic device 100 may identify whether the size of data to be transmitted exceeds the threshold value.

For reference, FIG. 7 illustrates the case in which the size of the data to be transmitted does not exceed the threshold value. Thus, when it is determined that the size of the data to be transmitted does not exceed the threshold value, operation S708 may be performed after operation S707.

In operation S708, the electronic device 100 may transmit the data having the size not exceeding the threshold value by using the intermediate device. The electronic device 100 may transmit the data having the size not exceeding the threshold value through the indirect communication. The electronic device 100 may transmit the data to be transmitted to the external device 200 through the indirect communication. The electronic device 100 may transmit the data to the external device 200 through the first connection and the second connection. According to an embodiment of the disclosure, the intermediate device 300 may include an access point or a router.

FIG. 8 illustrates a condition in which data, the size of which exceeds a threshold value, is transmitted, and a method of transmitting the data.

For reference, FIG. 8 illustrates a process of determining the threshold value according to the method of transmitting the data in the condition described with reference to FIGS. 6 and 7.

Referring to FIG. 8, the electronic device 100 and the external device 200 may set indirect communication through the intermediate device 300. The indirect communication may be established through a first connection between the electronic device 100 and the intermediate device 300 and a second connection between the external device 200 and the intermediate device 300. For example, the indirect communication may be realized through Wi-Fi, but the described indirect communication does not limit the technical aspect of the disclosure.

The electronic device 100 and the external device 200 may set direct communication without the help of the intermediate device 300. For example, the direct communication may be realized through BLE, but the described direct communication does not limit the technical aspect of the disclosure.

Hereinafter, a method of determining the threshold value and transmitting the data in the condition illustrated in FIG. 8 is described.

A process of deducing (obtaining) the threshold value is described below. The Equation 1, which is reproduced below, is used for the process of obtaining the threshold value. Also, the Equation 1 is only an example and does not limit the technical aspect of the disclosure.

$${x}^{′} = x * {R}_{ω} * {F}_{ω} / ( {R}_{d} * {F}_{d} ) \qquad [ Equation 1 ] ( reproduced )$$

### 1. Signal Strength R_{ω} of Indirect Communication.

According to an embodiment of the disclosure, the indirect communication may include the first connection between the electronic device 100 and the intermediate device 300 and the second connection between the external device 200 and the intermediate device 300. The signal strength of the indirect communication may be one of the signal strength of the first connection and the signal strength of the second connection. The electronic device may determine one of the signal strength of the first connection and the signal strength of the second connection and may obtain the determined signal strength as the signal strength of the indirect communication.

According to an embodiment of the disclosure, the electronic device 100 may determine a weaker signal strength of the signal strength of the first connection and the signal strength of the second connection as the signal strength of the indirect communication. The weaker signal strength of the signal strengths of the plurality of connections may induce a bottle neck phenomenon in data transmission, and thus, may be determined as the signal strength of the indirect communication. The electronic device 100 may determine the weaker signal strength of the signal strength of the first connection and the signal strength of the second connection as the signal strength of the indirect communication and may obtain the threshold value based on the determined signal strength of the indirect communication.

For example, as illustrated in FIG. 8, the signal strength of the first connection may be 87 dBm. The signal strength of the second connection may be 88 dBm. Thus, the signal strength of the first connection may be weaker than the signal strength of the second connection. The electronic device 100 may determine the signal strength of the first connection, which is 87 dBm, as the signal strength of the indirect communication. The signal strength R_{ω} of the indirect communication may be 87 dBm.

According to an embodiment of the disclosure, the signal strength may be represented as a normalized numerical value of between 0 and 100.

### 2. Network Frequency F_{ω} of Indirect Communication

According to an embodiment of the disclosure, the indirect communication may include a first connection between the electronic device 100 and the intermediate device 300 and a second connection between the external device 200 and the intermediate device 300. The network frequency of the indirect communication may be one of the network frequency of the first connection and the network frequency of the second connection. The electronic device 100 may determine one of the network frequency of the first connection and the network frequency of the second connection and may obtain the determined network frequency as the network frequency of the indirect communication.

According to an embodiment of the disclosure, the electronic device 100 may determine a weaker network frequency of the network frequency of the first connection and the network frequency of the second connection as the network frequency of the indirect communication. The weaker network frequency of the network frequencies of the plurality of connections may induce a bottle neck phenomenon in data transmission, and thus, may be determined as the network frequency of the indirect communication. The electronic device 100 may determine the weaker network frequency of the network frequency of the first connection and the network frequency of the second connection as the network frequency of the indirect communication and may obtain the threshold value based on the determined network frequency of the indirect communication.

According to an embodiment of the disclosure, the network frequency F_{ω} of the indirect communication may be a multiplying factor corresponding to the frequency of the indirect communication. The electronic device 100 may obtain the multiplying factor corresponding to the frequency of the indirect communication.

For example, the electronic device 100 may obtain the multiplying factor corresponding to the frequency of the first connection. The electronic device 100 may obtain the multiplying factor corresponding to the frequency of the second communication. The electronic device 100 may determine a weaker frequency of the frequency of the first connection and the frequency of the second connection. The electronic device 100 may obtain the multiplying factor corresponding to the connection having the weaker frequency as the network frequency F_{ω} of the indirect communication.

Table 1 (below) shows the corresponding relationship between the frequency and the multiplying factor. The method of determining the network frequency of the indirect communication is described again by using Table 1. However, the corresponding relationship shown in the table is only an example and does not limit the technical aspect of the disclosure.

TABLE 1

| Frequency | Multiplying Factor |
|---|---|
| 2.4 GHz | 1 |
| 5 GHz | 7 |

For example, as illustrated in FIG. 8, the frequency of the first connection may be 2.4 GHz. Based on Table 1, the multiplying factor corresponding to the frequency of the first connection is 1. Thus, the network frequency of the first connection may be determined to be 1. The frequency of the second connection may be 5 GHz. Based on Table 1, the multiplying factor corresponding to the frequency of the second connection is 7. Thus, the network frequency of the second connection may be determined to be 7.

The electronic device 100 may determine a weaker frequency of the frequency of the first connection and the frequency of the second connection and may determine the multiplying factor corresponding to the weaker network frequency as the network frequency F_{ω} of the indirect communication. For example, the electronic device 100 may select the frequency of the first connection that is 2.4 GHz, which is the weaker frequency of the frequency of the first connection and the frequency of the second connection. The multiplying factor corresponding to the frequency of 2.4 GHz is 1, and the electronic device 100 may obtain 1 as the network frequency F_{ω} of the indirect communication. The network frequency F_{ω} of the indirect communication may be determined to be 1.

### 3. Network Frequency F_{d} of Direct Communication

According to an embodiment of the disclosure, the signal strength R_{d} of the direct communication may be 74 dBm.

According to an embodiment of the disclosure, the electronic device 100 may determine the network frequency of the direct communication based on the signal strength of the direct communication. The electronic device 100 may indirectly determine the network frequency of the direct communication based on the signal strength of the direct communication.

According to an embodiment of the disclosure, the electronic device 100 may obtain a multiplying factor corresponding to a case in which the signal strength of the direct communication exceeds a threshold strength. The electronic device 100 may obtain a multiplying factor corresponding to a case in which the signal strength of the direct communication does not exceed the threshold strength.

For example, the electronic device 100 may obtain the signal strength of the direct communication. The electronic device 100 may obtain whether or not the signal strength of the direct communication exceeds the threshold strength. The electronic device 100 may obtain the multiplying factor corresponding to the case in which the signal strength of the direct communication exceeds the threshold strength. Alternatively, the electronic device 100 may obtain the multiplying factor corresponding to the case in which the signal strength of the direct communication does not exceed the threshold strength. The numerical value of the threshold strength may be arbitrarily set.

Table 2 below is shown to describe a corresponding relationship between the signal strength of the direct communication and the multiplying factor. The method of determining the network frequency of the direct communication is described again by using Table 2. However, the corresponding relationship shown in the table is only an example and does not limit the technical aspect of the disclosure.

TABLE 2

| Signal Strength | |
|---|---|
| of Direct | |
| Communication | Multiplying Factor |
| >90 | 7 |
| ≤90 | 1 |

For example, as illustrated in FIG. 8, the signal strength of the direct communication may be 74 dBm. Based on Table 2, the multiplying factor corresponding to the signal strength 74 dBm of the direct communication is 1. Thus, the network frequency of the direct communication may be determined to be 1.

The electronic device 100 may obtain the signal strength of the direct communication and may determine the multiplying factor corresponding to the obtained signal strength of the direct communication as the network frequency F_{d} of the direct communication. The network frequency F_{ω} of the direct communication may be determined to be 1.

4. Deduction of Threshold Value x′

According to an embodiment of the disclosure, the threshold value x′ may be determined according to Equation 1.

For example, the initial value x may be set as 51 MB. Also, it is only an example and does not limit the technical aspect of the disclosure.

According to an embodiment of the disclosure, the signal strength R_{ω} of the indirect communication may be 87 dBm. The network frequency F_{ω} of the indirect communication may be 1. The signal strength R_{d} of the direct communication may be 74 dBm. The network frequency F_{ω} of the direct communication may be 1. The initial value x may be 51 MB. According to Equation 1, the threshold value x′ may be 60 MB.

The electronic device 100 may determine the threshold value to be 60 MB.

### 5. Data Transmission Based on Determined Threshold Value

According to an embodiment of the disclosure, the electronic device 100 may determine whether or not the data to be transmitted exceeds the threshold value.

According to an embodiment of the disclosure, when the data to be transmitted exceeds 60 MB, the electronic device 100 may determine a data transmission method as direct communication. The electronic device 100 may transmit the data exceeding 60 MB to the external device 200 through the direct communication.

According to an embodiment of the disclosure, when the data to be transmitted is less than 60 MB, the electronic device 100 may determine the data transmission method as indirect communication. The electronic device 100 may transmit the data less than 60 MB to the external device 200 through the indirect communication.

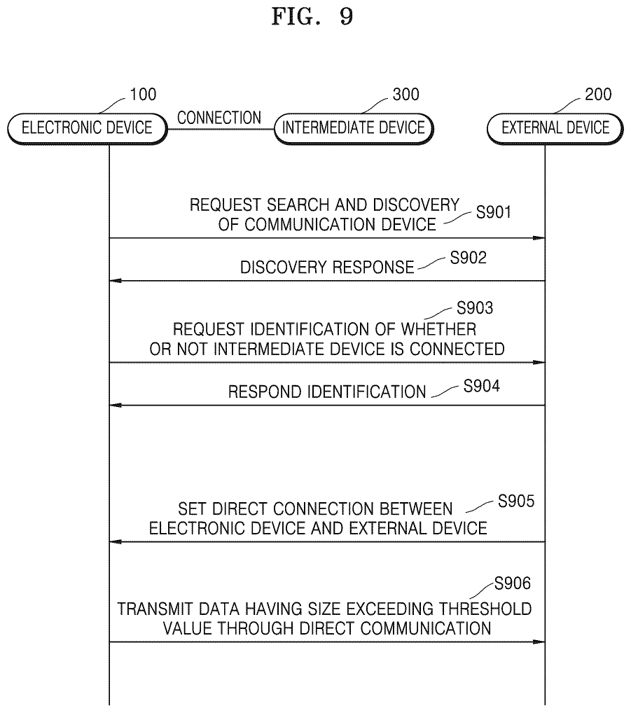

FIG. 9 illustrates a method of transmitting data to an external device, for which a communication connection is not set through the same intermediate device, according to an embodiment of the disclosure.

The descriptions about operations S901 and S902 are the same as described with reference to operations S601 and S602 of FIG. 6, and thus, are briefly given.

Referring to FIG. 9, in operation S901, the electronic device 100 may search for a communication device in the vicinity thereof. The electronic device 100 may transmit a discovery request with respect to the communication device in the vicinity thereof. The electronic device 100 may transmit a discovery request with respect to the external device 200. In operation S902, the electronic device 100 may receive a discovery response from the searched communication device. The electronic device 100 may receive a discovery response from the external device 200.

In operation S903, the electronic device 100 may transmit, to the searched communication device, a request of identification with respect to whether or not the searched communication device is connected to the intermediate device 300. The electronic device 100 may transmit, to the external device 200, a request of identification with respect to whether or not the external device 200 is connected to the intermediate device 300. In operation S904, the electronic device 100 may receive an identification response from the searched communication device. The electronic device 100 may receive an identification response from the external device 200.

For reference, FIG. 9 illustrates a case in which the external device 200 and the intermediate device 300 are not connected to each other. Thus, in operation S904, the electronic device 100 may receive, from the external device 200, the identification response indicating that a connection between the external device 200 and the intermediate device 300 is not set.

In operation S905, the electronic device 100 may set a direct connection between the electronic device 100 and the external device 200. The direct connection may indicate the direct communication according to the disclosure, and, for example, may be realized through Wi-Fi direct (Wi-Fi P2P), Bluetooth, BLE, NFC, a USB

In operation S906, the electronic device 100 may transmit data of the size exceeding a threshold value through the direct communication. The description about operation S906 may be the same as described with reference to operation S460 of FIG. 4, and thus, is omitted.

A method according to an embodiment of the disclosure may include obtaining first communication information with respect to direct communication between a first device and a second device. The method may include obtaining second communication information with respect to indirect communication between the first device and the second device through an intermediate device. The method may include determining, based on the first communication information and the second communication information, a threshold value for determining one of the direct communication and the indirect communication. The method may include determining, based on whether or not a size of data exceeds the threshold value, a communication method of transmitting the data from the first device to the second device.

According to an embodiment of the disclosure, the first communication information may include at least one of a network frequency of the direct communication or a signal strength of the direct communication.

According to an embodiment of the disclosure, the threshold value may be inversely proportional to at least one of the network frequency of the direct communication or the signal strength of the direct communication.

According to an embodiment of the disclosure, the indirect communication may include a first connection between the intermediate device and the first device and a second connection between the intermediate device and the second device.

According to an embodiment of the disclosure, the obtaining of the second communication information may include determining a communication path from the first connection between the intermediate device and the first device and the second connection between the intermediate device and the second device. The obtaining of the second communication information may include obtaining the second communication information with respect to the determined communication path.

According to an embodiment of the disclosure, the second communication information may include at least one of a network frequency of the indirect communication or a signal strength of the indirect communication.

According to an embodiment of the disclosure, the threshold value may be proportional to at least one of the network frequency of the indirect communication or the signal strength of the indirect communication.

According to an embodiment of the disclosure, the threshold value may correspond to a size of the data at which a data transmission rate is reversed between the direct communication and the indirect communication.

According to an embodiment of the disclosure, the method may further include, when the size of the data exceeds the threshold value, transmitting the data from the first device to the second device through the direct communication.

According to an embodiment of the disclosure, the method may further include, when the size of the data does not exceed the threshold value, transmitting the data from the first device to the second device through the indirect communication.

An electronic device according to an embodiment of the disclosure may include memory and at least one processor. The memory may store one or more instructions. The at least one processor may be configured to execute the one or more instructions stored in the memory. The at least one processor may be configured to execute the one or more instructions to obtain first communication information with respect to direct communication with an external device. The at least one processor may be configured to obtain second communication information with respect to indirect communication with the external device through an intermediate device. The at least one processor may be configured to determine, based on the first communication information and the second communication information, a threshold value of a size of data for determining one of the direct communication and the indirect communication. The at least one processor may be configured to determine, based on whether or not the size of the data exceeds the threshold value, a transmission method of transmitting the data to the external device.

According to an embodiment of the disclosure, the first communication information may include at least one of a network frequency of the direct communication or a signal strength of the direct communication.

According to an embodiment of the disclosure, the threshold value may be inversely proportional to at least one of the network frequency of the direct communication or the signal strength of the direct communication.

According to an embodiment of the disclosure, the indirect communication may include a first connection between the electronic device and the intermediate device and a second connection between the intermediate device and the external device.

According to an embodiment of the disclosure, the at least one processor may further be configured to determine a communication path from the first connection between the electronic device and the intermediate device and the second connection between the intermediate device and the external device. The at least one processor may further be configured to obtain the second communication information with respect to the determined communication path.

According to an embodiment of the disclosure, the second communication information may include at least one of a network frequency of the indirect communication or a signal strength of the indirect communication.

According to an embodiment of the disclosure, the threshold value may be proportional to at least one of the network frequency of the indirect communication or the signal strength of the indirect communication.

According to an embodiment of the disclosure, the at least one processor may further be configured to transmit the data through the direct communication, when the size of the data exceeds the threshold value.

According to an embodiment of the disclosure, the at least one processor may further be configured to transmit the data to the external device through the indirect communication, when the size of the data does not exceed the threshold value.

According to an embodiment of the disclosure, there may be provided a computer-readable recording medium having recorded thereon a program for executing, on a computer, any one of the methods described above or below that are related to the operations of the electronic device.

Machine-readable storage media may be provided as non-transitory storage media. Here, the term “non-transitory storage media” only denotes that the media are tangible devices and do not include signals (e.g., electromagnetic waves), and does not distinguish the storage media semi-permanently storing data and the storage media temporarily storing data. For example, the “non-transitory storage media” may include a buffer temporarily storing data.

According to an embodiment of the disclosure, the method according to various embodiments disclosed in the present specification may be provided as an inclusion of a computer program product. The computer program product may be, as a product, transacted between a seller and a purchaser. The computer program product may be distributed in the form of a machine-readable storage medium (e.g., a CD-ROM) or may be distributed online (e.g., downloaded or uploaded) through an application store or directly between two user devices (e.g., smartphones). In the case of online distribution, at least part of a computer program product (e.g., a downloadable application) may be at least temporarily stored in a machine-readable storage medium, such as a server of a manufacturer, a server of an application store, or a memory of a relay server, or may be temporarily generated.

What is claimed is:

1. A method, performed by a first device, comprising:
obtaining first communication information on direct communication between the first device and a second device;
obtaining second communication information on indirect communication between the first device and the second device through an intermediate device;
determining, based on the first communication information and the second communication information, a threshold value for determining either the direct communication or the indirect communication; and
determining, based on a determination that a size of data exceeds the threshold value or not, either the direct communication or the indirect communication as a communication method of transmitting the data from the first device to the second device.

2. The method of claim 1, wherein the first communication information comprises at least one of a network frequency of the direct communication or a signal strength of the direct communication.

3. The method of claim 2, wherein the threshold value is inversely proportional to at least one of the network frequency of the direct communication or the signal strength of the direct communication.

4. The method of claim 1, wherein the indirect communication comprises a first connection between the intermediate device and the first device and a second connection between the intermediate device and the second device.

5. The method of claim 4, wherein the obtaining of the second communication information comprises:
determining a communication path from the first connection between the intermediate device and the first device and the second connection between the intermediate device and the second device; and
obtaining the second communication information on the determined communication path.

6. The method of claim 1, wherein the second communication information comprises at least one of a network frequency of the indirect communication or a signal strength of the indirect communication.

7. The method of claim 6, wherein the threshold value is proportional to at least one of the network frequency of the indirect communication or the signal strength of the indirect communication.

8. The method of claim 1, wherein the threshold value corresponds to a size of the data at which a data transmission rate is reversed between the direct communication and the indirect communication.

9. The method of claim 8, further comprising, in a case where the size of the data exceeds the threshold value, transmitting the data from the first device to the second device through the direct communication.

10. The method of claim 8, further comprising, in a case where the size of the data does not exceed the threshold value, transmitting the data from the first device to the second device through the indirect communication.

11. An electronic device comprising:
memory storing one or more instructions; and
at least one processor configured to execute the one or more instructions stored in the memory to:
obtain first communication information on direct communication with an external device;
obtain second communication information to indirect communication with the external device through an intermediate device;
determine, based on the first communication information and the second communication information, a threshold value of a size of data for determining either the direct communication or the indirect communication; and
determine, based on whether the size of the data exceeds the threshold value or not, a transmission method of transmitting the data to the external device.

12. The electronic device of claim 11, wherein the first communication information comprises at least one of a network frequency of the direct communication or a signal strength of the direct communication.

13. The electronic device of claim 12, wherein the threshold value is inversely proportional to at least one of the network frequency of the direct communication or the signal strength of the direct communication.

14. The electronic device of claim 11, wherein the indirect communication comprises a first connection between the electronic device and the intermediate device and a second connection between the intermediate device and the external device.

15. The electronic device of claim 14, wherein the at least one processor is further configured to execute the one or more instructions stored in the memory to:
determine a communication path from the first connection between the electronic device and the intermediate device and the second connection between the intermediate device and the external device; and
obtain the second communication information on the determined communication path.

16. The electronic device of claim 11, wherein the second communication information comprises at least one of a network frequency of the indirect communication or a signal strength of the indirect communication.

17. The electronic device of claim 16, wherein the threshold value is proportional to at least one of the network frequency of the indirect communication or the signal strength of the indirect communication.

18. The electronic device of claim 17, wherein the at least one processor is further configured to execute the one or more instructions stored in the memory to transmit the data to the external device through the direct communication, in a case where the size of the data exceeds the threshold value.

19. The electronic device of claim 17, wherein the at least one processor is further configured to execute the one or more instructions stored in the memory to transmit the data to the external device through the indirect communication, in a case where the size of the data does not exceed the threshold value.

20. A computer-readable recording intermediate device having recorded thereon a program for executing:
obtaining, by a first device, first communication information on direct communication between the first device and a second device;
obtaining, by the first device, second communication information on indirect communication between the first device and the second device through an intermediate device;
determining, by the first device, based on the first communication information and the second communication information, a threshold value for determining either the direct communication or the indirect communication; and
determining, by the first device, based on a determination that a size of data exceeds the threshold value or not, either the direct communication or the indirect communication as a communication method of transmitting the data from the first device to the second device.
